(19) United States
(12) Patent Application Publication
(10) Pub. No.: US 2025/0371185 A1
(43) Pub. Date: Dec. 4, 2025

(54) SYSTEMS AND METHODS FOR DYNAMIC POLICY GENERATION AND COMPLIANCE IN A TRUSTED COMPUTING ENVIRONMENT

(71) Applicant: BeeKeeperAI, Inc., Austin, TX (US)

(72) Inventors: Michael Scott Blum, Scottsdale, AZ (US); Pavan Gupta, Oakland, CA (US); Robert Derward Rogers, Oakland, CA (US)

(21) Appl. No.: 19/224,939

(22) Filed: Jun. 2, 2025

Related U.S. Application Data
(60) Provisional application No. 63/655,063, filed on Jun. 2, 2024.

(51) Int. Cl. G06F 21/62

(52) U.S. Cl. CPC G06F 21/6218

(57) ABSTRACT

Systems and methods related to the generation and application of dynamic policies in a zero-trust computing environment are provided. In some embodiments, the method of dynamic policy application comprises receiving a query. Data and an algorithm are then processed in response to the query on a runtime server within a trusted computing environment to generate a result. A dynamic outbound policy is generated responsive to a data steward. It is used to validate the result. The result may be shared as output when the result meets the criteria of the dynamic outbound policy, otherwise the result may be rejected when the result fails to meet the criteria of the dynamic outbound policy. In addition to the dynamic outbound policy, the query may also be subjected to an inbound policy. This process may all occur in an iterative way within a Jupyter Notebook environment.

### CROSS REFERENCE TO RELATED APPLICATIONS

This application claims the benefit and is a non-provisional of U.S. Provisional Application No. 63/655,063 filed Jun. 2, 2024 entitled “Systems and methods for dynamic policy generation and compliance in a trusted computing environment”, which application is incorporated in its entirety by this reference.

### BACKGROUND

The present invention relates in general to the field of confidential computing, and more specifically to methods, computer programs and systems for the generation and application of dynamic security policies in iterative queries of an algorithm on a dataset. Such systems and methods are particularly useful for ensuring individual data stewards maintain a level of desired security and control over the allowed output of an algorithm. Through federated learning, the system may enable a normalized query to be generated that operates consistently across different data stewards with varying dynamic policies.

Within certain fields, there is a distinguishment between the developers of algorithms (often machine learning of artificial intelligence algorithms), and the stewards of the data that said algorithms are intended to operate with and be trained by. For the avoidance of doubt, an algorithm may include a model, code, pseudo-code, source code, or the like. On its surface, this seems to be an easily solved problem of merely sharing either the algorithm or the data that it is intended to operate with. However, in reality, there is often a strong need to keep the data and the algorithm secret. For example, the companies developing their algorithms may have the bulk of their intellectual property tied into the software comprising the algorithm. For many of these companies, their entire value may be centered in their proprietary algorithms. Sharing such sensitive data is a real risk to these companies, as the leakage of the software base code could eliminate their competitive advantage overnight.

One could imagine that instead, the data could be provided to the algorithm developer for running their proprietary algorithms and generation of the attendant reports. However, the problem with this methodology is two-fold. Firstly, the datasets for processing are often extremely large, requiring significant time to transfer the data from the data steward to the algorithm developer. Indeed, sometimes the datasets involved consume petabytes of data. The fastest fiber optics internet speed in the US is 2,000 MB/second. At this speed, transferring a petabyte of data can take nearly seven days to complete. It should be noted that most commercial internet speeds are a fraction of this maximum fiber optic speed.

The second reason that the datasets are not readily shared with the algorithm developers is that the data itself may be secret in some manner. For example, the data could also be proprietary, being of a significant asset value. Moreover, the data may be subject to some controls or regulations. This is particularly true in the case of medical information. Protected health information, or PHI, for example, is subject to a myriad of laws, such as HIPAA and GDPR, that include strict requirements on the sharing of PHI, and are subject to significant fines if such requirements are not adhered to.

Healthcare related information is of particular focus in this application. Of all the global stored data, about 30% resides in healthcare. This data provides a treasure trove of information for algorithm developers to train their specific algorithm models (AI or otherwise) and allows for the identification of correlations and associations within datasets. Such data processing allows advancements in the identification of individual pathologies, public health trends, treatment success metrics, and the like. Such output data from the running of these algorithms may be invaluable to individual clinicians, healthcare institutions, and private companies (such as pharmaceutical and biotechnology companies). At the same time, the adoption of clinical AI has been slow. Data access is a major barrier to clinical approval. The FDA requires proof that a model works across the entire population. However, privacy protections make it challenging to access enough diverse data to accomplish this goal.

To further complicate matters, different data stewards may have different privacy needs. These needs may be driven by regulation (based upon the types of data being accessed), internal decision making, or contractual obligations. Thus, even when operating in a secure environment, it is often the case that each different data steward may have differing requirements on which types of outputs are deemed acceptable.

Given that there is great value in the ability to run AI models on data sets in a secure manner, while being subject to a configurable set of output constraints, systems and methods of dynamic security policy generation and implementation are provided.

### SUMMARY

The present systems and methods relate to the generation and application of dynamic policies in a zero-trust computing environment. These systems and methods enable highly tailored query experiences where a data steward can configure the types and degrees of acceptable outputs. Through federated policy aggregation, queries can be constructed which provide the necessary degree of output while meeting all data steward policies, thereby generating normalized outputs.

In some embodiments, the method of dynamic policy application comprises receiving a query. Data and an algorithm are then processed in response to the query on a runtime server within a trusted computing environment to generate a result. A dynamic outbound policy is generated responsive to a data steward. It is used to validate the result. The result may be shared as output when the result meets the criteria of the dynamic outbound policy, otherwise the result may be rejected when the result fails to meet the criteria of the dynamic outbound policy. The system may also be designed to generate a recommendation on how to meet the dynamic outbound policy when the result fails to meet the criteria of the dynamic outbound policy. The recommendation may be a modified query, for example. In some cases, the result may also be modified in order to have the result meet the criteria of the dynamic outbound policy. This process may all occur in an iterative way within a Jupyter Notebook environment.

In addition to the dynamic outbound policy, the query may also be subjected to an inbound policy, wherein the inbound policy excludes the query and/or the algorithm from exfiltration of sensitive data. The inbound policy can be static or dynamic.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1A and 1B are example block diagrams of a system for zero trust computing of data by an algorithm, in accordance with some embodiment;

FIG. 2 is an example block diagram showing the core management system, in accordance with some embodiment;

FIG. 3 is an example block diagram showing an example model for the confidential computing data flow, in accordance with some embodiment;

FIG. 4 is a flowchart for an example process for the operation of the confidential computing data processing system, in accordance with some embodiment;

FIG. 5 a flowchart for an example process of acquiring and curating data, in accordance with some embodiment;

FIG. 6 a flowchart for an example process of onboarding a new host data steward, in accordance with some embodiment;

FIG. 7 is a flowchart for an example process of encapsulating the algorithm and data, in accordance with some embodiment;

FIG. 8 is a flowchart for an example process of algorithm encryption and handling, in accordance with some embodiment;

FIG. 9 is an example block diagram showing a trusted computing environment with dynamic policies being generated and enforced via a policy agent, in accordance with some embodiment;

FIG. 10 is workstream diagram of various computations through project runs where dynamic policies are employed, in accordance with some embodiment;

FIG. 11 is an flow diagram an example process of an iterative project run with dynamic policies, in accordance with some embodiment;

FIG. 12 is a flowchart for an example process of data processing within a project run, in accordance with some embodiment;

FIG. 13 is a flowchart for an example process of a policy compliance decision step, in accordance with some embodiment;

FIG. 14 is a flowchart for an example process of federated learning of a best-fit normalized query, in accordance with some embodiment; and

FIGS. 15A and 15B are illustrations of computer systems capable of implementing the confidential computing, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for the confidential computing application on one or more algorithms processing sensitive datasets. Such systems and methods may be applied to any given dataset, but may have particular utility within the healthcare setting, where the data is extremely sensitive. As such, the following descriptions will center on healthcare use cases. This particular focus, however, should not artificially limit the scope of the invention. For example, the information processed may include sensitive industry information, financial, payroll or other personally identifiable information, or the like. As such, while much of the disclosure will refer to protected health information (PHI) it should be understood that this may actually refer to any sensitive type of data. Likewise, while the data stewards are generally thought to be a hospital or other healthcare entity, these data stewards may in reality be any entity that has and wishes to process their data within a zero-trust environment.

In some embodiments, the following disclosure will focus upon the term “algorithm”. It should be understood that an algorithm may include machine learning (ML) models, neural network models, or other artificial intelligence (AI) models. However, algorithms may also apply to more mundane model types, such as linear models, least mean squares, or any other mathematical functions that convert one or more input values, and results in one or more output models.

Also, in some embodiments of the disclosure, the terms “node”, “infrastructure” and “enclave” may be utilized. These terms are intended to be used interchangeably and indicate a computing architecture that is logically distinct (and often physically isolated). In no way does the utilization of one such term limit the scope of the disclosure, and these terms should be read interchangeably.

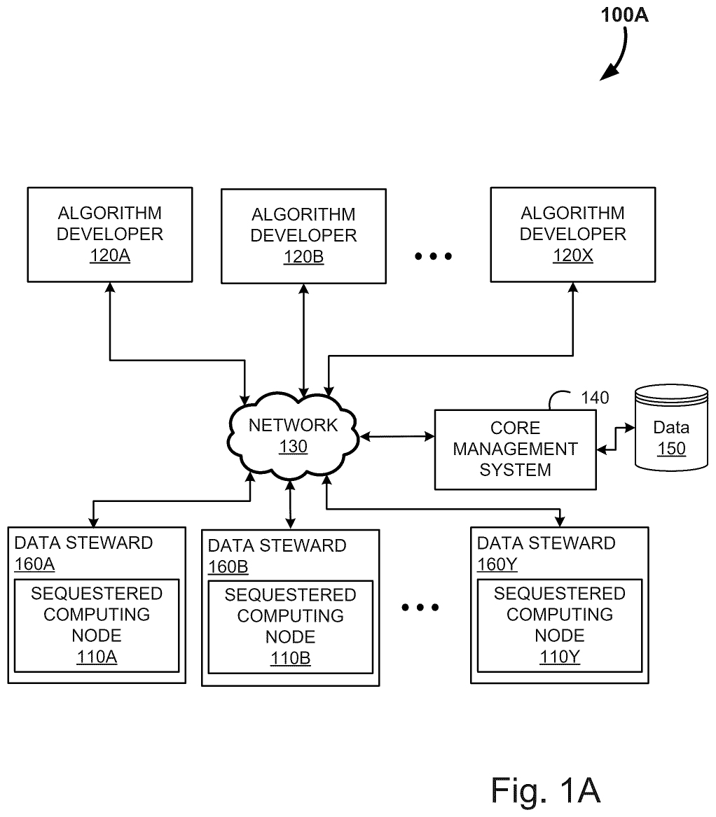

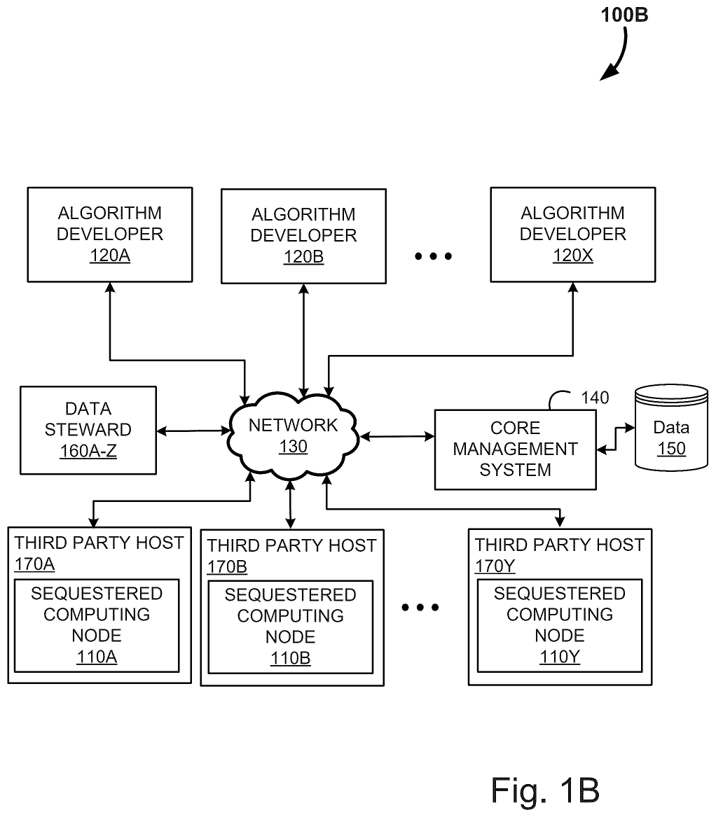

To facilitate discussions, FIG. 1A is an example of a confidential computing infrastructure, shown generally at 100a. This infrastructure includes one or more algorithm developers 120a-x which generate one or more algorithms for processing of data, which in this case is held by one or more data stewards 160a-y. The algorithm developers are generally companies that specialize in data analysis, and are often highly specialized in the types of data that are applicable to their given models/algorithms. However, sometimes the algorithm developers may be individuals, universities, government agencies, or the like. By uncovering powerful insights in vast amounts of information, AI and machine learning (ML) can improve care, increase efficiency, and reduce costs. For example, AI analysis of chest x-rays predicted the progression of critical illness in COVID-19. In another example, an image-based deep learning model developed at MIT can predict breast cancer up to five years in advance. And yet another example is an algorithm developed at University of California San Francisco, which can detect pneumothorax (collapsed lung) from CT scans, helping prioritize and treat patients with this life-threatening condition—the first algorithm embedded in a medical device to achieve FDA approval.

Likewise, the data stewards may include public and private hospitals, companies, universities, banks and other financial institutions, governmental agencies, or the like. Indeed, virtually any entity with access to sensitive data that is to be analyzed may be a data steward.

The generated algorithms are encrypted at the algorithm developer in whole, or in part, before transmitting to the data stewards, in this example ecosystem. The algorithms are transferred via a core management system 140, which may supplement or transform the data using a localized datastore 150. The core management system also handles routing and deployment of the algorithms. The datastore may also be leveraged for key management in some embodiments that will be discussed in greater detail below.

Each of the algorithm developer 120a-x, and the data stewards 160a-y and the core management system 140 may be coupled together by a network 130. In most cases the network is comprised of a cellular network and/or the internet. However, it is envisioned that the network includes any wide area network (WAN) architecture, including private WAN's, or private local area networks (LANs) in conjunction with private or public WANs.

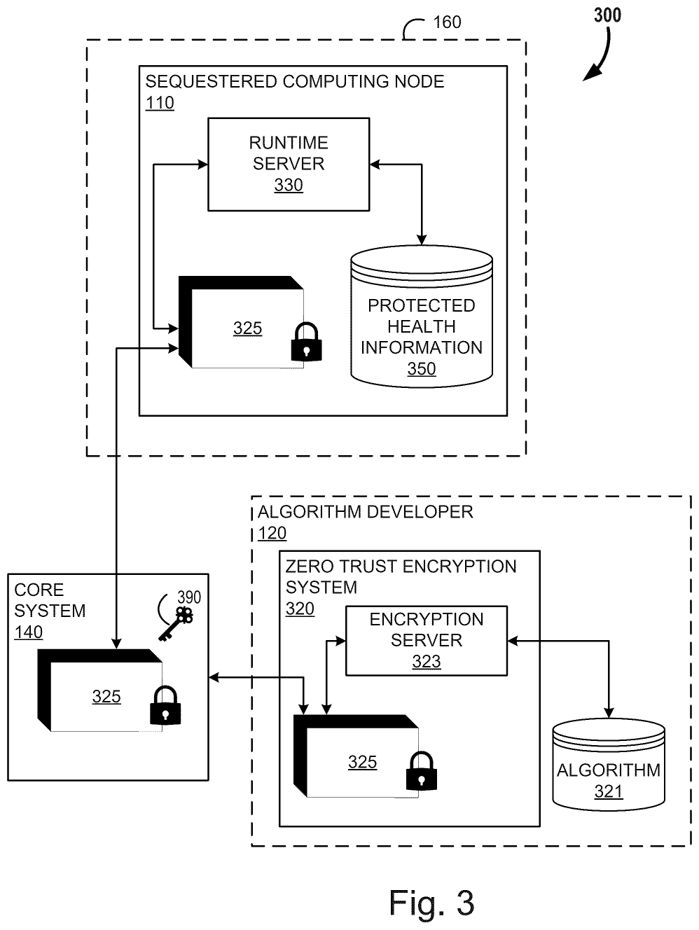

In this particular system, the data stewards maintain sequestered computing nodes 110a-y which function to actually perform the computation of the algorithm on the dataset. The sequestered computing nodes, or “enclaves”, may be physically separate computer server systems, or may encompass virtual machines operating within a greater network of the data steward's systems. The sequestered computing nodes should be thought of as a vault. The encrypted algorithm and encrypted datasets are supplied to the vault, which is then sealed. Encryption keys 390, as seen in FIG. 3, unique to the vault are then provided, which allows the decryption of the data and models to occur. No party has access to the vault at this time, and the algorithm is able to securely operate on the data. The data and algorithms may then be destroyed, or maintained as encrypted, when the vault is “opened” in order to access the report/output derived from the application of the algorithm on the dataset. Due to the specific sequestered computing node being required to decrypt the given algorithm(s) and data, there is no way they can be intercepted and decrypted. This system relies upon public-private key techniques, where the algorithm developer utilizes the public key 390 for encryption of the algorithm, and the sequestered computing node includes the private key in order to perform the decryption. In some embodiments, the private key may be hardware (in the case of Azure, for example) or software linked (in the case of AWS, for example). In other embodiments, the algorithm may be encrypted using a symmetric key, and the symmetric key may be wrapped encrypted by a public key. Specifically, the algorithm developer has their own symmetrical key (content encryption key) used to encrypt the algorithm. The algorithm developer uses the public key to encrypt or “wrap” the content encryption key. The unwrapping occurs in the vault using the private half of the key, to then enable the content encryption key to decrypt the algorithm.

In some particular embodiments, the system sends algorithm models via an Azure Confidential Computing environment to a data steward's environment. Upon verification, the model and the data entered the Intel SGX sequestered enclave where the model is able to be validated against the protected information, for example PHI, data sets. Throughout the process, the algorithm owner cannot see the data, the data steward cannot see the algorithm model, and the management core can see neither the data nor the model. It should be noted that an Intel SGX enclave is but one substantiation of a hardware enabled trusted execution environment. Other hardware and/or software enabled trusted execution environments may be readily employed in other embodiments.

The data steward uploads encrypted data to their cloud environment using an encrypted connection that terminates inside an Intel SGX-sequestered enclave. In some embodiments, the encrypted data may go into Blob storage prior to terminus in the sequestered enclave, where it is pulled upon as needed. Then, the algorithm developer submits an encrypted, containerized AI model which also terminates into an Intel SGX-sequestered enclave. In some specific embodiments, a key management system in the management core enables the containers to authenticate and then run the model on the data within the enclave. In alternate embodiments, where distributed keys are utilized, there is no need for a key management system. Rather in such embodiments, the system is fully distributed among the parties, as shall be described in greater detail below. The data steward never sees the algorithm inside the container and the data is never visible to the algorithm developer. Neither component leaves the enclave. After the model runs, in some embodiments the developer receives a performance report on the values of the algorithm's performance. Finally, the algorithm owner may request that an encrypted artifact containing information about validation results is stored for regulatory compliance purposes and the data and the algorithm are wiped from the system.

FIG. 1B provides a similar ecosystem 100b. This ecosystem also includes one or more algorithm developers 120a-x, which generate, encrypt and output their models. The core management system 140 receives these encrypted payloads, and in some embodiments, transforms or augments unencrypted portions of the payloads. The major difference between this substantiation and the prior figure, is that the sequestered computing node(s) 110a-y are present within a third-party host 170a-y. An example of a third-party host may include an offsite server such as Amazon Web Service (AWS) or similar cloud infrastructure. Other examples can include any network-connected environment, such as traditional data centers. In such situations, the data steward encrypts their dataset(s) and provides them, via the network, to the third party hosted sequestered computing node(s) 110a-y. The output of the algorithm running on the dataset is then transferred from the sequestered computing node in the third-party, back via the network to the data steward (or potentially some other recipient).

In some specific embodiments, the system relies on a unique combination of software and hardware available through Azure Confidential Computing. The solution uses virtual machines (VMs) running on specialized Intel processors with Intel Software Guard Extension (SGX), in this embodiment, running in the third-party system. Intel SGX creates sequestered portions of the hardware's processor and memory known as “enclaves” making it impossible to view data or code inside the enclave. Software within the management core handles encryption, key management, and workflows.

In some embodiments, the system may be some hybrid between FIGS. 1A and 1B. For example, some datasets may be processed at local sequestered computing nodes, especially extremely large datasets, and others may be processed at third parties. Such systems provide flexibility based upon computational infrastructure, while still ensuring all data and algorithms remain sequestered and not visible except to their respective owners.

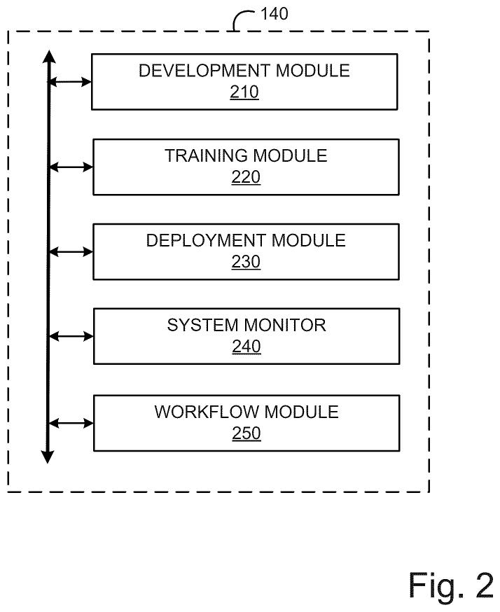

Turning now to FIG. 2, greater detail is provided regarding the core management system 140. The core management system 140 may include a data science development module 210, a data harmonizer workflow creation module 250, a software deployment module 230, a federated master algorithm training module 220, a system monitoring module 240, and a data store comprising global join data 240.

The data science development module 210 may be configured to receive input data requirements from the one or more algorithm developers for the optimization and/or validation of the one or more models. The input data requirements define the objective for data curation, data transformation, and data harmonization workflows. The input data requirements also provide constraints for identifying data assets acceptable for use with the one or more models. The data harmonizer workflow creation module 250 may be configured to manage transformation, harmonization, and annotation protocol development and deployment. The software deployment module 230 may be configured along with the data science development module 210 and the data harmonizer workflow creation module 250 to assess data assets for use with one or more models. This process can be automated or can be an interactive search/query process. The software deployment module 230 may be further configured along with the data science development module 210 to integrate the models into a sequestered capsule computing framework, along with required libraries and resources.

In some embodiments, it is desired to develop a robust, superior algorithm/model that has learned from multiple disjoint private data sets (e.g., clinical and health data) collected by data hosts from sources (e.g., patients). The federated master algorithm training module may be configured to aggregate the learning from the disjoint data sets into a single master algorithm. In different embodiments, the algorithmic methodology for the federated training may be different. For example, sharing of model parameters, ensemble learning, parent-teacher learning on shared data and many other methods may be developed to allow for federated training. The privacy and security requirements, along with commercial considerations such as the determination of how much each data system might be paid for access to data, may determine which federated training methodology is used.

The system monitoring module 240 monitors activity in sequestered computing nodes. Monitored activity can range from operational tracking such as computing workload, error state, and connection status as examples to data science monitoring such as amount of data processed, algorithm convergence status, variations in data characteristics, data errors, algorithm/model performance metrics, and a host of additional metrics, as required by each use case and embodiment.

In some instances, it is desirable to augment private data sets with additional data located at the core management system (join data 150). For example, geolocation air quality data could be joined with geolocation data of patients to ascertain environmental exposures. In certain instances, join data may be transmitted to sequestered computing nodes to be joined with their proprietary datasets during data harmonization or computation.

The sequestered computing nodes may include a harmonizer workflow module 250, harmonized data, a runtime server, a system monitoring module, and a data management module (not shown). The transformation, harmonization, and annotation workflows managed by the data harmonizer workflow creation module may be deployed by and performed in the environment by harmonizer workflow module using transformations and harmonized data. In some instances, the join data may be transmitted to the harmonizer workflow module to be joined with data during data harmonization. The runtime server may be configured to run the private data sets through the algorithm/model.

The system monitoring module monitors activity in the sequestered computing node. Monitored activity may include operational tracking such as algorithm/model intake, workflow configuration, and data host onboarding, as required by each use case and embodiment. The data management module may be configured to import data assets such as private data sets while maintaining the data assets within the pre-exiting infrastructure of the data stewards.

Turning now to FIG. 3, an example of the flow of algorithms and data are provided, generally at 300. The Zero-Trust Encryption System 320 manages the encryption, by an encryption server 323, of all the algorithm developer's 120 software assets 321 in such a way as to prevent exposure of intellectual property (including source or object code) to any outside party, including the entity running the core management system 140 and any affiliates, during storage, transmission and runtime of said encrypted algorithms 325. In this embodiment, the algorithm developer is responsible for encrypting the entire payload 325 of the software using its own encryption keys. Decryption is only ever allowed at runtime in a sequestered capsule computing environment 110.

The core management system 140 receives the encrypted computing assets (algorithms) 325 from the algorithm developer 120. Decryption keys to these assets are not made available to the core management system 140 so that sensitive materials are never visible to it. The core management system 140 distributes these assets 325 to a multitude of data steward nodes 160 where they can be processed further, in combination with private datasets, such as protected health information (PHI) 350.

Each Data Steward Node 160 maintains a sequestered computing node 110 that is responsible for allowing the algorithm developer's encrypted software assets 325 (the “algorithm” or “algo”) to compute on a local private dataset 350 that is initially encrypted. Within data steward node 160, one or more local private datasets (not illustrated) is harmonized, transformed, and/or annotated and then this dataset is encrypted by the data steward, into a local dataset 350, for use inside the sequestered computing node 110.

The sequestered computing node 110 receives the encrypted software assets 325 and encrypted data steward dataset(s) 350 and manages their decryption in a way that prevents visibility to any data or code at runtime at the runtime server 330. In different embodiments this can be performed using a variety of secure computing enclave technologies, including but not limited to hardware-based and software-based isolation.

In this present embodiment, the entire algorithm developer software asset payload 325 is encrypted in a way that it can only be decrypted in an approved sequestered computing enclave/node 110. This approach works for sequestered enclave technologies that do not require modification of source code or runtime environments in order to secure the computing space (e.g., software-based secure computing enclaves).

The Algorithm developer 120 generates an algorithm, which is then encrypted and provided as an encrypted algorithm payload 325 to the core management system 140. As discussed previously, the core management system 140 is incapable of decrypting the encrypted algorithm 325. Rather, the core management system 140 controls the routing of the encrypted algorithm 325 and the management of keys. The encrypted algorithm 325 is then provided to the data steward 160 which is then “placed” in the sequestered computing node 110. The data steward 160 is likewise unable to decrypt the encrypted algorithm 325 unless and until it is located within the sequestered computing node 110, in which case the data steward still lacks the ability to access the “inside” of the sequestered computing node 110. As such, the algorithm is never accessible to any entity outside of the algorithm developer.

Likewise, the data steward 160 has access to protected health information and/or other sensitive information. The data steward 160 never is required to transfer this data outside of its ecosystem (an if it is, it may remain in an encrypted state) thus ensuring that the data is always inaccessible by any other party by virtue of it remaining encrypted when accessible by any other party. The sensitive data may be encrypted (or remain in the clear) as it is also transferred into the sequestered computing node 110. This data store is made accessible to the runtime server 330 also located “inside” the sequestered computing node 110. The runtime server 330 decrypts the encrypted algorithm 325 to yield the underlying algorithm model. This algorithm may then use the data store to generate inferences regarding the date contained in the data store (not illustrated). These inferences have value for the data steward 110 as well as other interested parties and may be outputted to the data steward (or other interested parties such as researchers or regulators) for consumption. The runtime server 330 may likewise engage in training activities.

The runtime server 330 may also perform a number of other operations, such as the generation of a performance model or the like. The performance model is a regression model generated based upon the inferences derived from the algorithm. The performance model provides data regarding the performance of the algorithm based upon the various inputs. The performance model may model for any of algorithm accuracy, F1 score, precision, recall, dice score, ROC (receiver operator characteristic) curve/area, log loss, Jaccard index, error, R², by some combination thereof, or by any other suitable metric.

Once the algorithm developer 120 receives the performance model it may be decrypted, and leveraged to validate the algorithm and, importantly, may be leveraged to actively train the algorithm in the future. This may occur by identifying regions of the performance model that have lower performance ratings and identify attributes/variables in the datasets that correspond to these poorer performing model segments. The system then incorporates human feedback when such variables are present in a dataset to assist in generating a gold standard training set for these variable combinations. The performance model may then be trained based upon these gold standard training sets. Even without the generation of additional gold standard data, investigation of poorer performing model segments enables changes to the functional form of the model and testing for better performance. It is likewise possible that the inclusion of additional variables by the model allows for the distinction of attributes of a patient population. This is identified by areas of the model that has a lower performance which indicates that there is a fundamental issue with the model. An example is that a model operates well (has higher performance) for male patients as compared to female patients. This may indicate that different model mechanics may be required for female patient populations.

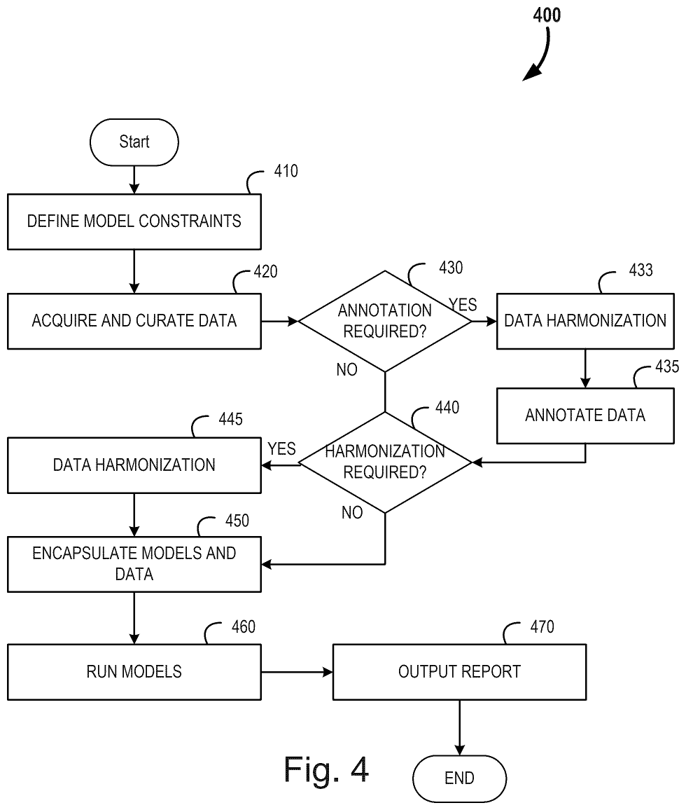

Turning to FIG. 4, one embodiment of the process for deployment and running of algorithms within the sequestered computing nodes is illustrated, at 400. Initially the algorithm developer provides the algorithm to the system using wheatever process they locally employ. For example, at least one algorithm/model is generated by the algorithm developer using their own development environment, tools, and seed data sets (e.g., training/testing data sets). In some embodiments, the algorithms may be trained on external datasets instead, as will be discussed further below. The algorithm developer provides constraints (at 410) for the optimization and/or validation of the algorithm(s). Constraints may include any of the following: (i) training constraints, (ii) data preparation constraints, and (iii) validation constraints. These constraints define objectives for the optimization and/or validation of the algorithm(s) including data preparation (e.g., data curation, data transformation, data harmonization, and data annotation), model training, model validation, and reporting.

In some embodiments, the training constraints may include, but are not limited to, at least one of the following: hyperparameters, regularization criteria, convergence criteria, algorithm termination criteria, training/validation/test data splits defined for use in algorithm(s), and training/testing report requirements. A model hyper parameter is a configuration that is external to the model, and which value cannot be estimated from data. The hyperparameters are settings that may be tuned or optimized to control the behavior of a ML or AI algorithm and help estimate or learn model parameters.

Regularization constrains the coefficient estimates towards zero. This discourages the learning of a more complex model in order to avoid the risk of overfitting. Regularization, significantly reduces the variance of the model, without a substantial increase in its bias. The convergence criterion is used to verify the convergence of a sequence (e.g., the convergence of one or more weights after a number of iterations). The algorithm termination criteria define parameters to determine whether a model has achieved sufficient training. Because algorithm training is an iterative optimization process, the training algorithm may perform the following steps multiple times. In general, termination criteria may include performance objectives for the algorithm, typically defined as a minimum amount of performance improvement per iteration or set of iterations.

The training/testing report may include criteria that the algorithm developer has an interest in observing from the training, optimization, and/or testing of the one or more models. In some instances, the constraints for the metrics and criteria are selected to illustrate the performance of the models. For example, the metrics and criteria such as mean percentage error may provide information on bias, variance, and other errors that may occur when finalizing a model such as vanishing or exploding gradients. Bias is an error in the learning algorithm. When there is high bias, the learning algorithm is unable to learn relevant details in the data. Variance is an error in the learning algorithm, when the learning algorithm tries to over-learn from the dataset or tries to fit the training data as closely as possible. Further, common error metrics such as mean percentage error and R² score are not always indicative of accuracy of a model, and thus the algorithm developer may want to define additional metrics and criteria for a more in depth look at accuracy of the model.

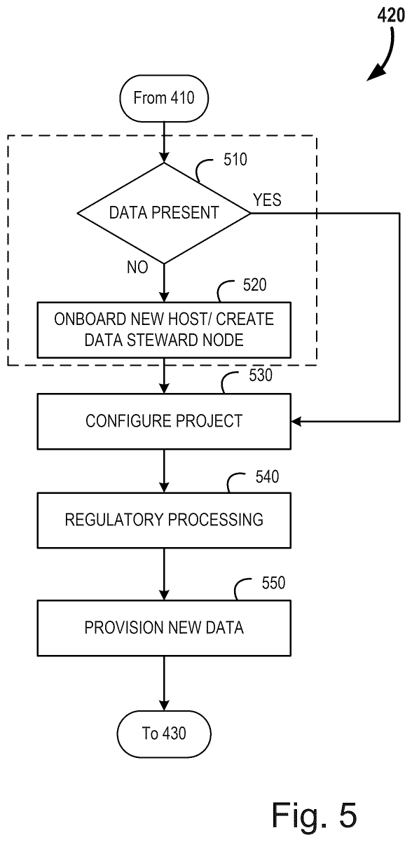

Next, data assets that will be subjected to the algorithm(s) are identified, acquired, and curated (at 420). FIG. 5 provides greater detail of this acquisition and curation of the data. Often, the data may include healthcare related data (PHI). Initially, there is a query if data is present (at 510). The identification process may be performed automatically by the platform running the queries for data assets (e.g., running queries on the provisioned data stores using the data indices) using the input data requirements as the search terms and/or filters. Alternatively, this process may be performed using an interactive process, for example, the algorithm developer may provide search terms and/or filters to the platform. The platform may formulate questions to obtain additional information, the algorithm developer may provide the additional information, and the platform may run queries for the data assets (e.g., running queries on databases of the one or more data hosts or web crawling to identify data hosts that may have data assets) using the search terms, filters, and/or additional information. In either instance, the identifying is performed using differential privacy for sharing information within the data assets by describing patterns of groups within the data assets while withholding private information about individuals in the data assets.

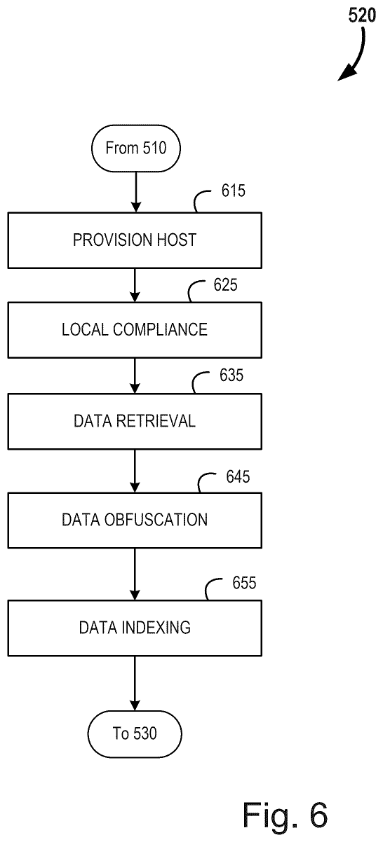

If the assets are not available, the process generates a new data steward node (at 520). The data query and onboarding activity (surrounded by a dotted line) is illustrated in this process flow of acquiring the data; however, it should be realized that these steps may be performed anytime prior to model and data encapsulation (step 450 in FIG. 6). Onboarding/creation of a new data steward node is shown in greater detail in relation to FIG. 6. In this example process a data host compute and storage infrastructure (e.g., a sequestered computing node as described with respect to FIGS. 1A-5) is provisioned (at 615) within the infrastructure of the data steward. In some instances, the provisioning includes deployment of encapsulated algorithms in the infrastructure, deployment of a physical computing device with appropriately provisioned hardware and software in the infrastructure, deployment of storage (physical data stores or cloud-based storage), or deployment on public or private cloud infrastructure accessible via the infrastructure, etc.

Next, governance and compliance requirements are performed (at 625). In some instances, the governance and compliance requirements includes getting clearance from an institutional review board, and/or review and approval of compliance of any project being performed by the platform and/or the platform itself under governing law such as the Health Insurance Portability and Accountability Act (HIPAA). Subsequently, the data assets that the data steward desires to be made available for optimization and/or validation of algorithm(s) are retrieved (at 635). In some instances, the data assets may be transferred from existing storage locations and formats to provisioned storage (physical data stores or cloud-based storage) for use by the sequestered computing node (curated into one or more data stores). The data assets may then be obfuscated (at 645). Data obfuscation is a process that includes data encryption or tokenization, as discussed in much greater detail below. Lastly, the data assets may be indexed (at 655). Data indexing allows queries to retrieve data from a database in an efficient manner. The indexes may be related to specific tables and may be comprised of one or more keys or values to be looked up in the index (e.g., the keys may be based on a data table's columns or rows).

Returning to FIG. 5, after the creation of the new data steward, the project may be configured (at 530). In some instances, the data steward computer and storage infrastructure is configured to handle a new project with the identified data assets. In some instances, the configuration is performed similarly to the process described of FIG. 6. Next, regulatory approvals (e.g., IRB and other data governance processes) are completed and documented (at 540). Lastly, the new data is provisioned (at 550). In some instances, the data storage provisioning includes identification and provisioning of a new logical data storage location, along with creation of an appropriate data storage and query structure.

Returning now to FIG. 4, after the data is acquired and configured, a query is performed if there is a need for data annotation (at 430). If so, the data is initially harmonized (at 433) and then annotated (at 435). Data harmonization is the process of collecting data sets of differing file formats, naming conventions, and columns, and transforming it into a cohesive data set. The annotation is performed by the data steward in the sequestered computing node. A key principle to the transformation and annotation processes is that the platform facilitates a variety of processes to apply and refine data cleaning and transformation algorithms, while preserving the privacy of the data assets, all without requiring data to be moved outside of the technical purview of the data steward.

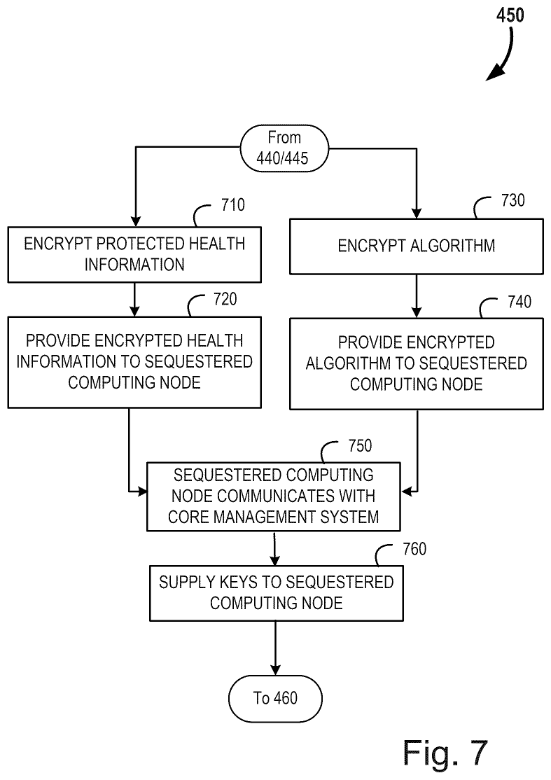

After annotation, or if annotation was not required, another query determines if additional data harmonization is needed (at 440). If so, then there is another harmonization step (at 445) that occurs in a manner similar to that disclosed above. After harmonization, or if harmonization isn't needed, the models and data are encapsulated (at 450). Data and model encapsulation is described in greater detail in relation to FIG. 7. In the encapsulation process the protected data, and the algorithm are each encrypted (at 710 and 730 respectively). In some embodiments, the data is encrypted either using traditional encryption algorithms (e.g., RSA) or homomorphic encryption.

Next the encrypted data and encrypted algorithm are provided to the sequestered computing node (at 720 and 740 respectively). There processes of encryption and providing the encrypted payloads to the sequestered computing nodes may be performed asynchronously, or in parallel. Subsequently, the sequestered computing node may phone home to the core management node (at 750) requesting the keys needed. These keys are then also supplied to the sequestered computing node (at 760), thereby allowing the decryption of the assets.

Returning again to FIG. 4, once the assets are all within the sequestered computing node, they may be decrypted and the algorithm may run against the dataset (at 460). The results from such runtime may be outputted as a report (at 470) for downstream consumption.

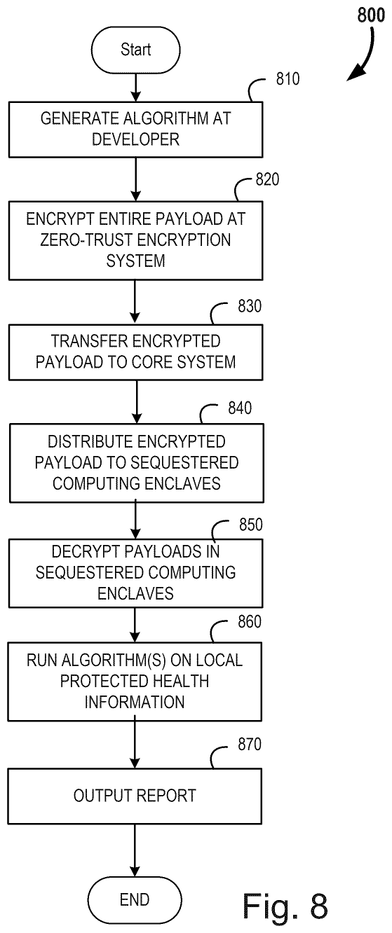

Turning now to FIG. 8, a first embodiment of the system for confidential computing processing of the data assets by the algorithm is provided, at 800. In this example process, the algorithm is initially generated by the algorithm developer (at 810) in a manner similar to that described previously. The entire algorithm, including its container, is then encrypted (at 820), using a public key, by the encryption server within the algorithm developer's infrastructure. The entire encrypted payload is provided to the core management system (at 830). The core management system then distributes the encrypted payload to the sequestered computing enclaves (at 840).

Likewise, the data steward collects the data assets desired for processing by the algorithm. This data is also provided to the sequestered computing node. In some embodiments, this data may also be encrypted. The sequestered computing node then contacts the core management system for the keys. The system relies upon public-private key methodologies for the decryption of the algorithm, and possibly the data (at 850).

After decryption within the sequestered computing node, the algorithm(s) are run (at 860) against the protected health information (or other sensitive information based upon the given use case). The results are then output (at 870) to the appropriate downstream audience (generally the data steward or algorithm developer, but may include public health agencies or other interested parties).

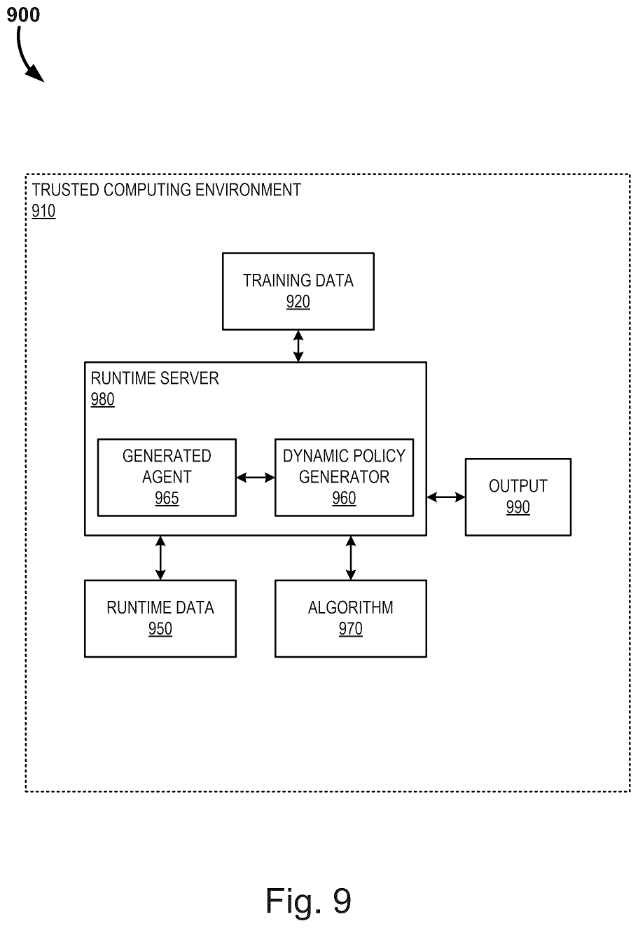

Turning now to FIG. 9, a block diagram 900 of a trusted computing environment 910 is provided. Within this trusted computing environment 910 is (optionally) training data 920 and/or runtime data 950. In this example illustration the trusted computing environment 910 is part of the data steward's computing infrastructure. This means any runtime data 950 and/or training data 920 is known to the hosting entity. However, in some other embodiments, the trusted computing environment 910 may be hosted by some other party, in which case any training 920 or runtime data 950 that is received will be in an encrypted format prior to being “locked” in the vault-like trusted computing environment 910. Similarly, an algorithm 970 may be provided in an encrypted form from an algorithm developer and likewise decrypted at the appropriate time within the trusted computing environment 910. This model is similar to that as described before in relation to the systems of FIGS. 1A-3. What makes this instant substantiation unique is the fact that the runtime server 980 includes an additional module: a dynamic policy generator 960.

The dynamic policy generator 960 may include a set of code alone, or hardware accelerated, which is able to receive input from the data steward (or other interested party), in the form of a specific script, or alternatively as a guidance document that is consumed by a foundational model in order to generate specific rules regarding output content. In one embodiment, the policy may be a json or other structured template that any output must explicitly adhere to, so that the format of the output and the contents are strictly controlled. This template is explicitly agreed to by the algorithm developer and each data steward. The advantage of a dynamic policy generator is that it can be used to secure computations that are carried out in multiple steps, applying appropriate controls to the output from each step. These rules are embodied in an agent 965 which is generated by the policy generator 960. The generated agent 965 operates within the runtime server 980 to consume the results of any given project run and approve, modify or reject the results before they are released as output 990. Additionally, within the runtime server may be inbound static or dynamic policies (not illustrated). These inbound policies. Inbound policies are intended to explicitly or implicitly prevent damage to the contents of an enclave/sequestered computing environment. A static inbound policy might prevent operations such as delete * or write( ), or may only allow specific libraries that are known to be free of malicious code to be called during the computing process. A dynamic inbound policy would prevent damage to the contents of an enclave by observing the impact of a piece of code on the enclave and then reversing that action if the broader inbound data protection policy is violated. This enables protection from code that can damage the enclave but is not obviously malicious.

Inbound policies receive any initial query and vet the query for obvious policy deviations. For example, a query asking to release Social Security Numbers, would be a clear policy violation, and the inbound policy could shortcut the processing of the query and reject (with or without providing a recommendation) prior to the processing of the query. Even in lightweight Jupyter Notebook processing of small queries, the computational requirements of a project run are significant. By catching clear policy violations on the outset, these computational requirements can be reduced, providing the computer system with an improved performance and functionality. The inbound policy may likewise investigate the operability of the algorithm model itself. Much like a nefarious query, models may include functionality that violates the policy and the algorithm may be rejected, or in some situations modified or a recommendation for modification can be provided. For example, an offending model could perform admirably, but could during training be instructed to exfiltrate data by storing the data in the least significant digits of a weight vector. In this example, the model does a clear and deliberate policy violation through intentional data exfiltration. In some embodiments, the systems inbound policy may inspect the algorithm for such violations, and take action as needed to protect the training and/or runtime data from exposure.

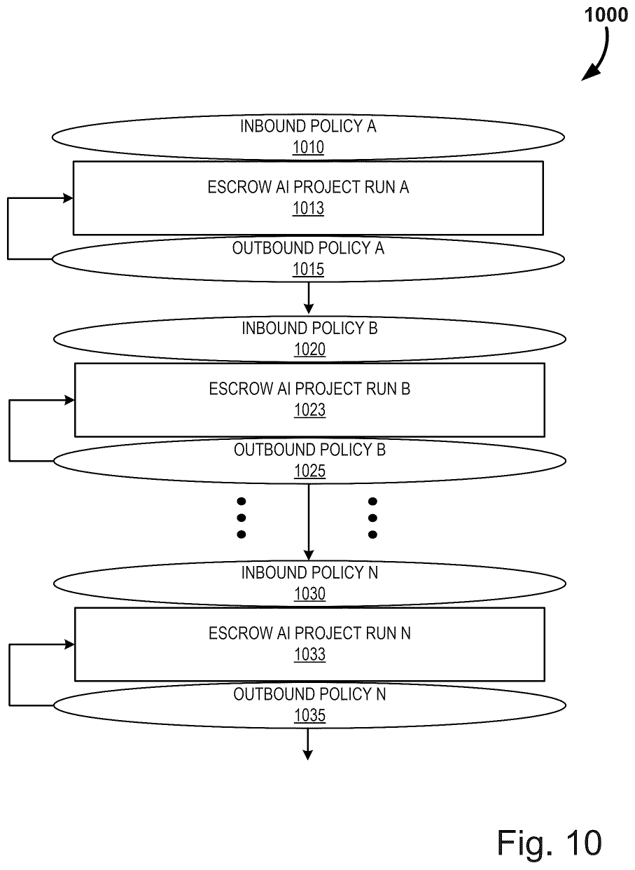

Turning to FIG. 10, a block diagram 1000 of multiple project runs is provided. In some embodiments, Jupyter Notebooks can be leveraged for the query process. In this example figure, each runtime cycle consists of an initial screening of the inbound query and algorithm by an inbound policy. Here we start with a check by inbound policy A 1010. The inbound policy can be static or dynamic as already noted.

Sometimes the inbound policy, if it determines there is a policy violation, may be able to provide one or more recommendations to alter the query and/or algorithm to pass the initial inbound policy check. For example, a query may request all records for patients exhibiting signs of a given pathology. This may clearly violate the policy against exporting personally identifiable information, and is immediately rejected. However the system may also be configured to present alternate types of deidentified information, such as numbers of impacted patients, aggregated data or the like. This alternate response pattern may be used to edit the query and provide a recommendation. A concrete example of this is the user asking the system to “Provide all data for patients exhibiting signs of diabetes.” The system may return with the following message: “Your query is invalid as it requests the release of sensitive data, however an acceptable query would include a request for the number of patients exhibiting signs of diabetes, and any common attributes among this population. Would you like to run this query?”

Such complex query recommendations are made possible by training a global model (independent of the algorithm) which collects various queries and identifies which queries are allowed by the policies (both inbound and outbound) and uses this corpus of data, in conjunction with foundational models, to generate acceptable recommendations. How a recommendation is generated may depend upon the kind of policy violation that occurred. For example, if a request to delete data or write to the enclave data is made, then a recommendation to enter a different query would be made, for example to write to cache rather than to the enclave database. If the violation exposes individual elements of a private dataset, then the recommendation could be to carry out that code request but to display the results of the computation on synthetic data. Alternatively, the recommendation could be to apply an aggregation operation to the results so that individual records are protected but a statistical understanding of the resulting data can be gained by the algorithm developer.

After review by the inbound policy A 1010, if acceptable, the query may undergo an EscrowAI Project Run A 1013. For simplicity, a project run is described as a single step in relation to this figure, however, as previously discussed, a project run is a complex and involved process requiring attestation and other techniques to maintain zero trust among the various parties, as described in relation to FIGS. 1A-8. A central part of the EscrowAI Project Run A 1013 is the generation of an agent by the dynamic policy generator located in the runtime server. This agent then operates against the results being generated by the runtime server. This includes a check against the outbound policy A 1015. The outbound policy inspects the results against a series of rules that define an acceptable output. It is entirely possible that a query may be benign and acceptable, and yet yield results that are unacceptable. For example, an acceptable query may include “what are the factors that increase the risk of mesothelioma within the target population?” The algorithm may identify that where the person lives impacts their risk factor, and an intended result may include address information. The outbound policy, however, would recognize that the address data is sensitive data and would block this information. In some embodiments, the system could reject all outputs (with or without a recommendation), or it could modify the results to be in an acceptable format. For example, the system could recognize that all the location data is within a given zip code. Rather than releasing home addresses then, the system could merely say that living within the particular zip code (or within X miles of a given coordinate/address, etc.) is a risk factor. After output is provided, it can be considered that a given cycle has completed. In some embodiments, this cycle is a single cell of a Jupyter Notebook. In a Jupyter Notebook environment or other interactive computing environment with dynamic policy controls, the kernel first applies an inbound policy, then securely runs each piece of code entirely within an enclave, and then applies an outbound policy to determine what information, if any, can be exported from the enclave (either to the interactive computing environment display or to an external storage location).

Subsequently, a second query or other action may be taken on the dataset as a subsequent cell of the Jupyter Notebook, starting with the review by inbound policy B 1020. In some cases, the inbound policies are static, and thus inbound policy A 1010 is the same as inbound policy B 1020. In alternate embodiments, these policies are dynamic, and may vary depending on query, number of iterations of project runs, etc. For example, inbound policy A 1010 may be relatively large and can do a ‘deep dive’ into the mechanics of the underlying algorithm. However, for later (or non-training) project runs, potentially later inbound policies may be lighter-weight pieces of code designed to search the query for offensive content but not requiring a full review of the algorithm (which has presumably already been fully vetted).

Regardless, inbound policy B 1020 undergoes a similar process of checking the algorithm and/or query for suitability and either allows the downstream processing on the data or rejects the query (with or without recommendation). Once a suitable algorithm and query are employed then there is another EscrowAI project run B 1023 where a policy agent is generated and processes the results of the project run in an outbound policy B check 1025. The results of which include acceptance of some output (raw or modified) or the return of the user to the project run if the results do not meet the policy. This completes another cell in the Jupyter Notebook.

This iterative sets of project runs may be repeated as required until a final project run is desired. Each project run includes review by the inbound policy N 1030, a project run N 1033, and finally an outbound policy N 1035 review. This iterative process may be performed on a single data steward, or across multiple data stewards with varying policy generators. For example, one data steward may include contractual reasons for heightened security, thereby preventing the release of nearly any part of a patient record. Such a data steward policy may require the generation of synthetic data in order to present results to the user. Another data steward, in contrast may be bound by regulation, but not such a heightened standard, and may therefore release data as long as it doesn't qualify as personably identifiable.

It is possible to use federated techniques to learn which queries are allowable across different data stewards to allow the “best” query that is deemed allowable across all stewards to be identified. Generally, the “best” query is the one which collects the most quantity or most accurate information. By learning what the best query is, it allows the system and/or user to ask consistent questions across all data stewards. This is important because by standardizing queries between the different data stewards the same outputs (normalized results) can be expected.

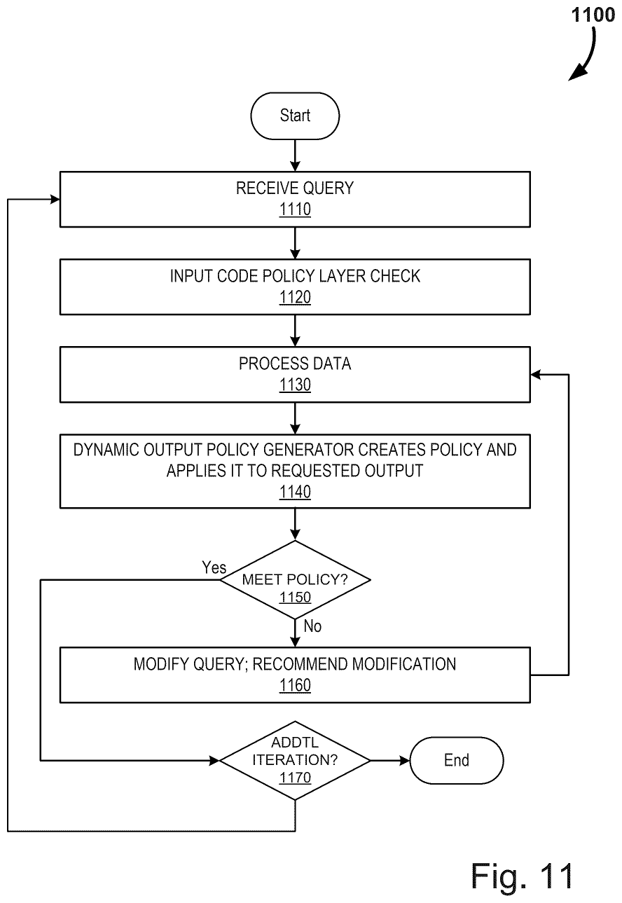

Turning now to FIG. 11, a flow diagram 1100 for the iterative example process of project runs with dynamic policies is provided. Initially in this process, the trusted computing environment is provisioned—the algorithm is provided to the trusted computing environment in an encrypted form. Data steward data is also provided to the trusted computing environment. Sometimes this data is for training, sometimes the data is processing data. In some embodiments, both data types are made available. This provisioning of the trusted computing environment is not illustrated for the sake of clarity, however, the various steps discussed previously in relation to FIGS. 4-8 may all be employed, as needed, to enable proper operation of the trusted computing environment in a zero-trust manner.

After the environment has been thusly provisioned, a query may be received (at 1110). This query may take the form as an input prompt in a Jupyter Notebook cell. In some embodiments, the query is a script or algorithm that operates upon the data steward's data. In other embodiments, the system may already have a generalized algorithm present in the trusted computing environment, and the query is asking the algorithm to perform a specified task. In some particular embodiments, the query may even include a natural language input question, which is transformed using an independent foundational model into a script. For example, natural language inputs could be converted to code via a code copilot LLM-type functionality that is restricted to using specific libraries and/or function calls that are known to be free of malicious code. The LLM may also be restricted from writing code that is in violation of the inbound policy.

After the query is received, there is the input code policy layer check (at 1120) by the inbound policy layer. As noted previously, the inbound policy may be a static or a dynamic policy.

The inbound policy check reviews the query and/or algorithm for policy violations. As previously mentioned, exfiltration techniques are generally what is identified and halted by the inbound policy. Ideally, the query and/or algorithm pass the inbound policy check, but in some cases there may be a violation that prevents the query or algorithm from being used. In this case the system can determine if the query or algorithm can be altered marginally to yield an acceptable result. If so, the change can be made, the user notified of the modification and the process can continue. For more substantive changes, the system may rather reject the query and/or algorithm and provide feedback to the user (not illustrated). This feedback may include, at a minimum, the reason for the rejection, and in some embodiments, where possible, a recommendation on how to alter the query or algorithm to meet the inbound policy.

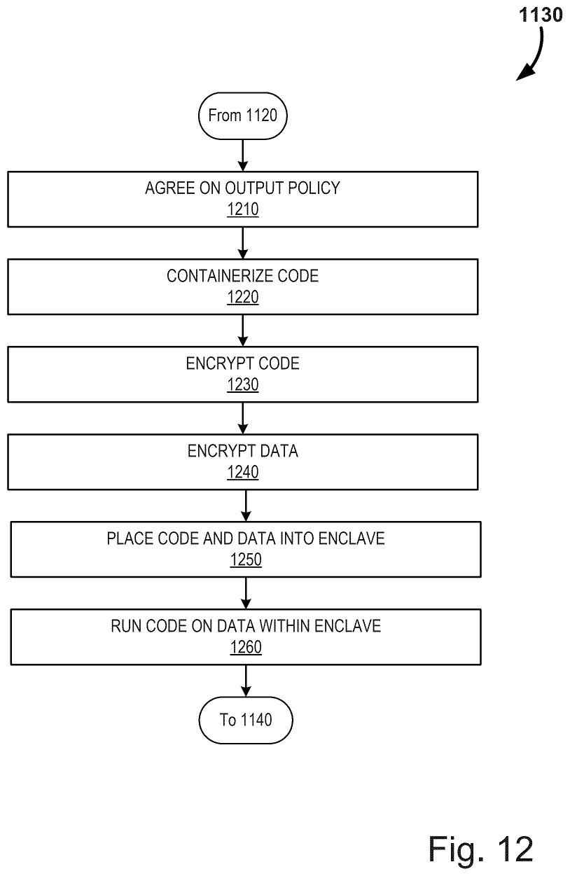

Assuming the query and algorithm meets the requirements of the inbound policy layer, the next stage is the processing of the data in accordance with the query and/or algorithm (at 1130). FIG. 12 provides a more detailed flow diagram of this data processing step. Even though this sub-process diagram is provided, a number of details related to the processing of data in a trusted manner are omitted, for the sake of clarity. For example, computing environment attestation for algorithm decryption and the like have been omitted from these example diagrams in order to not unnecessarily obscure the unique steps undertaken when operating with a dynamic policy. As such, any of the processing steps described previously in relation to FIGS. 1A-8 are considered incorporated into the data processing step as needed to effectuate zero-trust computing.

In this example sub process, initially the system agrees upon an output (outbound) policy (at 1210). This agreement is between the algorithm developer and data steward (the “counterparties”). There may be several fixed levels of security agreement between the counterparties depending upon their relationship. For example, an algorithm developer may have full, identified access to data in one enclave, while in another enclave (with a different data owner), they may have access to aggregated statistical results. In a third enclave, only results from synthetic data may be allowed, and in a fourth enclave, only high-level algorithm performance results may be allowed. Each of these levels of access are agreed by the counterparties at the outset of the project.

The code is containerized (at 1220) within a Jupyter Notebook, in some embodiments. While any computing environment could be managed in this way, this approach is directly applicable to interpreted language environments and interactive coding models, since security for each interactive step can be managed with an inbound and an outbound policy, and any violations can be negotiated in a step-by-step manner. Compiled software is typically run in a less interactive mode.

The code/algorithm is encrypted (at 1230) by the algorithm developer, as is the data (at 1240) by the data steward. These pieces of encrypted information are provided to the enclave (at 1250) for processing. An attestation process is employed to decrypt the code and data, and the runtime server can operate on them (at 1260) to perform the core of the project run.

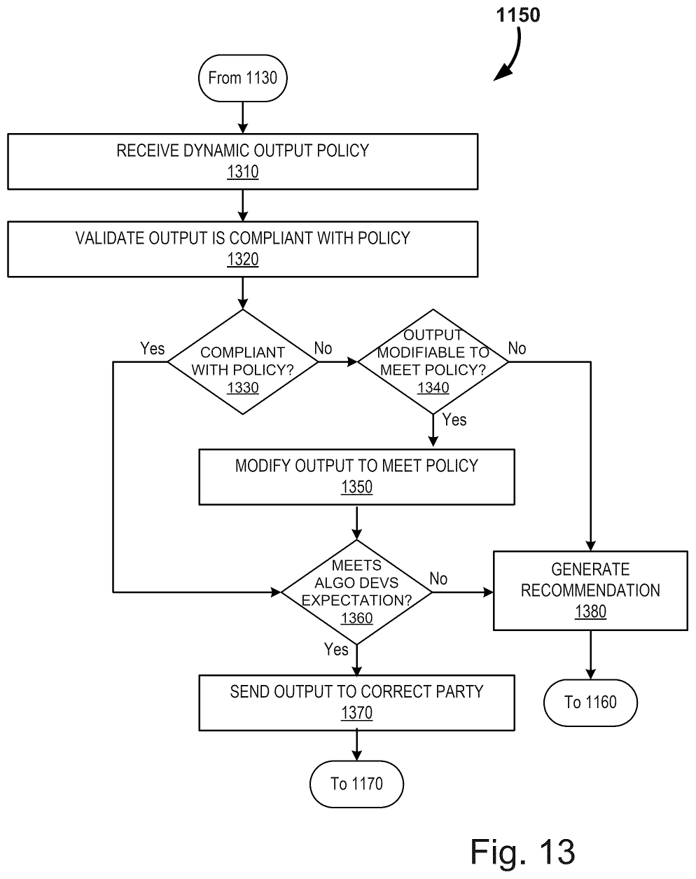

Returning to FIG. 11, after the data is processed, the dynamic output policy generator in the runtime server creates the policy based upon what was previously agree to, and outputs an agent to apply the outbound policy on the results of the data processing (at 1140). This policy check determines if the policy is being properly met (at 1150). This determination step is shown in greater detail in relation to FIG. 13. In this example sub-process, the dynamic output policy is received via the agent (at 1310). The output is validated, while in the runtime server, against the policy to ensure it is compliant (at 1320). A determination is made if the output is compliant (at 1330) and if so, a determination is made if the output meets the algorithm developer's expectations (at 1360). If the output is compliant with the policy and meets the algorithm developer's expectations, then the output is sent to the appropriate party (at 1370) and the process ends by returning to FIG. 11, where a determination is made whether to do another iteration (at 1170).

However, if the output is out of compliance with the policy (at 1330), then a further determination is made on whether the output can be modified to meet the policy (at 1340). If so, then the output may be so modified (at 1350) and a check is made if the modified output meets the algorithm developer's expectations (at 1360). If so, then the modified output can be provided to the correct party (at 1370) and the process ends by returning to FIG. 11, where a determination is made whether to do another iteration (at 1170).

However, if the output is not modifiable to meet the policy (at 1340) or if the output is not meeting the algorithm developer's expectations, a recommendation may be generated for what can be altered to make the output viable (at 1380). The process then ends by proceeding back to FIG. 11, where the query is modified and/or a recommendation for the modification is provided to the user (at 1160), and the new query is used to process the data (at 1130).

Otherwise, when the output is acceptable and provided back to the appropriate party, a determination is made if more iterations are desired (at 1170). If so, the whole process may be repeated with the receipt of a new query. If not, the process may conclude.

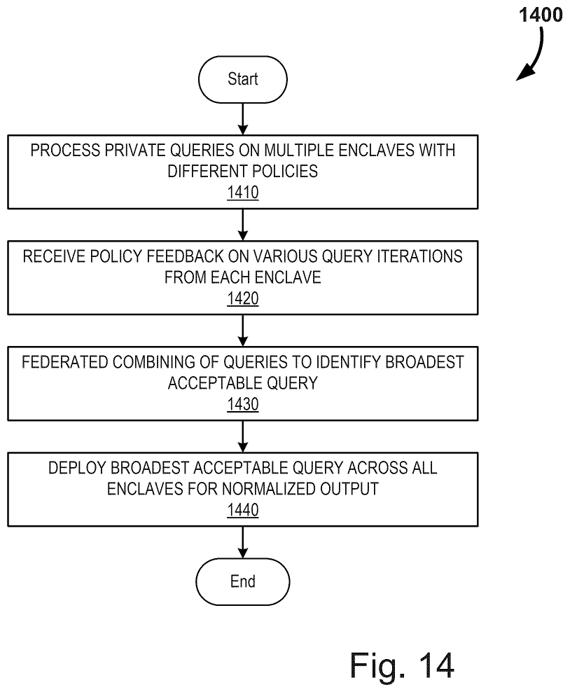

Turning now to FIG. 14, an example process 1400 is provided for the use of federated techniques to normalize a query from among many different data stewards. This allows for a single query to be deployed across the different data stewards and thereby normalize the results. The purpose of this process is that it enables a consistent set of outputs to be generated regardless of the data source, thereby enabling consolidated outputs and output comparison.

The initial step of this example process is to process multiple queries on multiple enclaves where the policies differ between enclaves (at 1410). Essentially, the processes of FIGS. 11-13 are repeated on different enclaves to complete this step. The policy feedback is received for the various query iterations from each enclave (at 1420). This allows for the usage of federated techniques to compile the queries to identify the broadest/best query (at 1430). Different metrics can be utilized to determine what the “best” query entails. One metric includes the volume of data that can be extracted from each given enclave. More data may indicate that the query can yield more information, and is therefore the “best”. Other metrics may include using algorithms to check for data accuracy and precision. Others may be based upon user feedback on what data is the most helpful. This analysis generally limits the query to what operates effectively in the strictest of the dynamic policies.

Once the “best” acceptable query is identified, it may be deployed across all enclaves (at 1440) to generate outputs that are consistent with one another. These results may then be compared, aggregated or otherwise analyzed as a unified set.

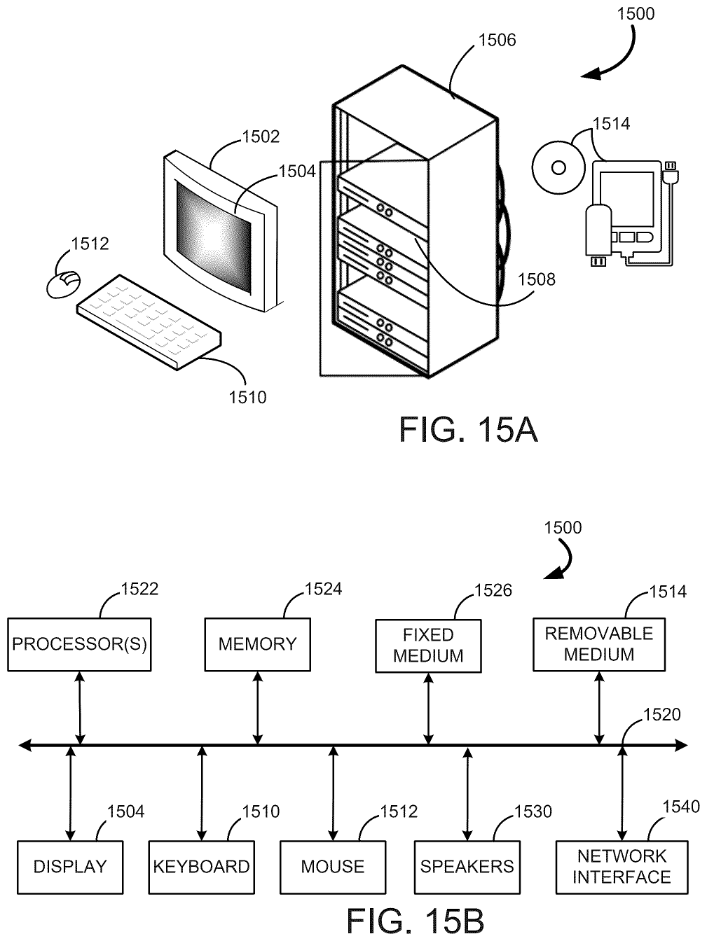

Now that the systems and methods for iterative project runtimes employing dynamic policies have been provided, attention shall now be focused upon apparatuses capable of executing the above functions in real-time. To facilitate this discussion, FIGS. 15A and 15B illustrate a Computer System 1500, which is suitable for implementing embodiments of the present invention. FIG. 15A shows one possible physical form of the Computer System 1500. Of course, the Computer System 1500 may have many physical forms ranging from a printed circuit board, an integrated circuit, and a small handheld device up to a huge supercomputer. Computer system 1500 may include a Monitor 1502, a Display 1504, a Housing 1506, server blades including one or more storage Drives 1508, a Keyboard 1510, and a Mouse 1512. Medium 1514 is a computer-readable medium used to transfer data to and from Computer System 1500. FIG. 15B is an example of a block diagram for Computer System 1500. Attached to System Bus 1520 are a wide variety of subsystems. Processor(s) 1522 (also referred to as central processing units, or CPUs) are coupled to storage devices, including Memory 1524. Memory 1524 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 1526 may also be coupled bi-directionally to the Processor 1522; it provides additional data storage capacity and may also include any of the computer-readable media described below. Fixed Medium 1526 may be used to store programs, data, and the like and is typically a secondary storage medium (such as a hard disk) that is slower than primary storage. It will be appreciated that the information retained within Fixed Medium 1526 may, in appropriate cases, be incorporated in standard fashion as virtual memory in Memory 1524. Removable Medium 1514 may take the form of any of the computer-readable media described below.

Processor 1522 is also coupled to a variety of input/output devices, such as Display 1504, Keyboard 1510, Mouse 1512 and Speakers 1530. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 1522 optionally may be coupled to another computer or telecommunications network using Network Interface 1540. With such a Network Interface 1540, it is contemplated that the Processor 1522 might receive information from the network, or might output information to the network in the course of performing the above-described confidential computing processing of protected information, for example PHI. Furthermore, method embodiments of the present invention may execute solely upon Processor 1522 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 1500 can be controlled by operating system software that includes a file management system, such as a medium operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. In a zero-trust computing environment, a computerized method iterative project runs with dynamic policy adherence, the method comprising:
receiving a query;
processing data and an algorithm in response to the query on a runtime server within a trusted computing environment to generate a result;
generating a dynamic outbound policy responsive to a data steward;
validating the result against the dynamic outbound policy;
sharing the result as output when the result meets the criteria of the dynamic outbound policy; and
rejecting the result when the result fails to meet the criteria of the dynamic outbound policy.

2. The method of claim 1, wherein the query is received in a Jupyter Notebook environment.

3. The method of claim 1, further comprising subjecting at least one of the query and the algorithm to an inbound policy, wherein the inbound policy excludes the at least one of the query and the algorithm from exfiltration of sensitive data.

4. The method of claim 3, wherein the inbound policy is static.

5. The method of claim 3, wherein the inbound policy is dynamic.

6. The method of claim 1, further comprising generating a recommendation on how to meet the dynamic outbound policy when the result fails to meet the criteria of the dynamic outbound policy.

7. The method of claim 6, wherein the recommendation is a modified query.

8. The method of claim 1, further comprising modifying the result in order to have the result meet the criteria of the dynamic outbound policy.

9. The method of claim 1, further comprising iteratively repeating the process with a new query at least once.

10. The method of claim 1, wherein the dynamic outbound policy varies across different data stewards.

11. In a zero-trust computing environment, a computerized method to standardize outputs across different data stewards with different dynamic security policies, the method comprising:
iteratively processing a plurality of queries at each of a plurality of data stewards;
using federated techniques collect feedback regarding the plurality of queries and results generated by each query at each data steward;
determining a best query which meets an objective at all data stewards; and
deploying the best query across all data stewards to generate normalized outputs.

12. The method of claim 11, wherein the processing comprises iteratively performing the steps of:
receiving a query;
processing data and an algorithm in response to the query on a runtime server within a trusted computing environment to generate a result;
generating a dynamic outbound policy responsive to a data steward;
validating the result against the dynamic outbound policy;
sharing the result as output when the result meets the criteria of the dynamic outbound policy; and
rejecting the result when the result fails to meet the criteria of the dynamic outbound policy.

13. The method of claim 12, further comprising subjecting at least one of the query and the algorithm to an inbound policy, wherein the inbound policy excludes the at least one of the query and the algorithm from exfiltration of sensitive data.

14. The method of claim 11, wherein the objective is getting the largest quantity of information back of all the queries in the results.

15. The method of claim 11, wherein the objective is a highest accuracy for the results from among all the queries.

16. The method of claim 11, wherein the objective is the highest feedback from a user for the results from among all the queries.

17. The method of claim 1, wherein the plurality of queries are received in a Jupyter Notebook environment.
